(19) United States
(12) Patent Application Publication
(10) Pub. No.: US 2025/0339983 A1
(43) Pub. Date: Nov. 6, 2025

(54) CLIPPER ASSEMBLY FOR CUTTING HAIR OF A PATIENT WITH NOISE SENSITIVITY

(71) Applicant: Derrick Marks, Milwaukee, WI (US)

(72) Inventor: Derrick Marks, Milwaukee, WI (US)

(21) Appl. No.: 19/196,649

(22) Filed: May 1, 2025

Related U.S. Application Data
(60) Provisional application No. 63/642,964, filed on May 6, 2024.

(51) Int. Cl. B26B 19/38

(52) U.S. Cl. CPC B26B 19/388; B26B 19/3853

(57) ABSTRACT

A clipper assembly includes a handle, a blade, a motor, and circuitry. The handle includes a first end, a second end, and a speaker positioned between the first end and the second end. The blade is coupled to the second end. The motor is positioned in the handle and is operable to actuate the blade. The circuitry is configured to control the speaker and the motor.

### CROSS-REFERENCE TO RELATED PATENT APPLICATIONS

This application claims priority to U.S. Provisional Application No. 63/642,964, filed on May 6, 2024, the entire contents of which is incorporated herein by reference.

### BACKGROUND

The present disclosure relates generally to barbering clippers. Clippers can be used in the barbering profession and/or by amateur users to cut a patient's hair and to trim beards.

### SUMMARY

In one embodiment, a clipper assembly comprises a handle, a blade, a motor, and circuitry. The handle includes a first end, a second end, and a speaker positioned between the first end and the second end. The blade is coupled to the second end. The motor is positioned in the handle and operable to actuate the blade. The circuitry is configured to control the speaker and the motor.

In another embodiment, a method of calming a patient with autism spectrum disorder receiving a haircut comprises turning on a speaker located inside a clipper assembly, controlling the speaker to emit a noise, actuating a blade of the clipper assembly by a motor of the clipper assembly, and cutting hair of a patient by the blade while emitting the noise by the speaker.

In yet another embodiment, a method of calming a patient with a sensory processing disorder receiving a haircut comprises turning on a speaker located inside a clipper assembly, controlling the speaker to emit a noise, actuating a blade of the clipper assembly by a motor of the clipper assembly, and cutting hair of the patient by the blade while emitting the noise by the speaker.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a perspective view of an example clipper assembly, according to some embodiments;

FIG. 2 is another perspective view of the clipper assembly shown in FIG. 1, according to some embodiments;

FIG. 3 is a block diagram of another example clipper assembly, according to some embodiments; and

FIG. 4 is a flowchart illustrating an example embodiment of the method for calming a patient using a clipper assembly, according to some embodiments.

### DETAILED DESCRIPTION

Following below are detailed descriptions of various concepts related to, and implementations of, methods, apparatuses, for providing a clipper assembly for a haircut for a patient with noise sensitivity challenges. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

An aspect of the present disclosure is a determination that it would be desirable to provide a productive, positive, and complete haircut experience for persons (individuals, barbering customers, patients, etc.) with noise sensitivity conditions. Such noise sensitivity conditions may include a condition such as autism spectrum disorder or sensory processing disorder. In the context of barbering (e.g., hair cutting, beard trimming, etc.), the present disclosure includes a determination that persons having noise sensitivity conditions can have a sensitivity to noises emitted from a barbering clippers, including but not limited to the noise emitted from a blade or a motor of the clippers. This noise sensitivity can provide a challenge to such persons in receiving a haircut performed using a conventional barbering clippers, and/or to a barber or other individual providing a haircut using a conventional barbering clippers due to auditory overstimulation caused by the noises emitted from the clipper and associated behaviors caused by such overstimulation which can interrupt completion of a haircut. That is, a conventional clippers may be loud and trigger sensory overload for a patient with noise sensitivity which causes the haircut process to be difficult or impossible for a patient with a noise sensitivity (whether such patient is the barber or the recipient of a haircut). Additionally, conventional clippers may cause a barber or other individual providing a haircut to pause the haircut when taking a phone call, leading to interruptions in the haircut that cause anxiety and discomfort for the person receiving the haircut. This is particularly challenging for individuals with sensory processing disorders, where interruptions can exacerbate their sensory overload, making the haircut experience more overwhelming and stressful.

Implementations described herein are related to a clipper assembly including a speaker, a motor, and a blade, and processes relating thereto. The clipper assembly uses the speaker to emit a noise from the speaker to cover (e.g., mask, dampen, drown out, etc.) a first noise profile emitted by the clipper assembly. The noise emitted from the speaker may be a comforting noise that the patient enjoys (i.e., their favorite song, nature sounds, etc.) to cover the first noise profile emitted by the clippers. In some embodiments, the clipper assembly can also perform an analysis of the first profile to create a second noise profile that least partially cancels out the first noise profile emitted by the clipper (e.g., via active noise canceling). The noise and the second noise profile emitted by the speaker can be increased or decreased in volume to accommodate patient or barber preferences. In some embodiments, the speaker is also configured to emit a second noise (e.g., a phone call, etc.). The speaker enables the barber or other individual providing the haircut to continue cutting the hair of the person receiving the haircut without stopping the haircut to receive a phone call. In this way, the clipper assembly is more desirable than other clipper systems which are not capable of being tailored to the needs of patients with noise sensitivity conditions (including, for example both recipients of haircuts having noise sensitivity conditions and barbers having noise sensitivity conditions). These and other features and advantages of the present application will be described in further detail below with reference to the Figures.

### II. Overview of Example Clipper Assembly

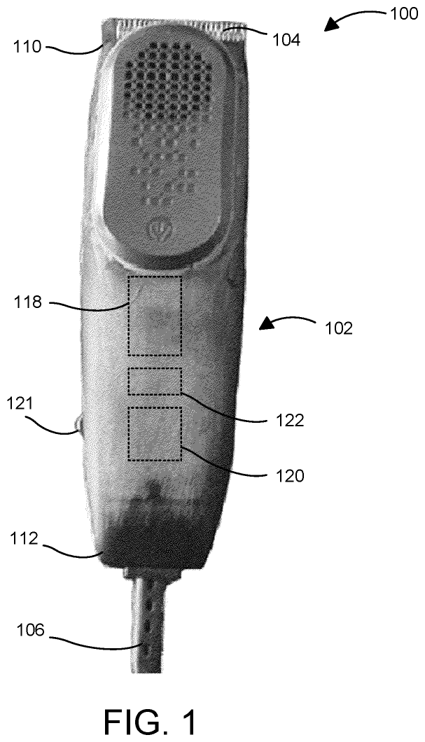

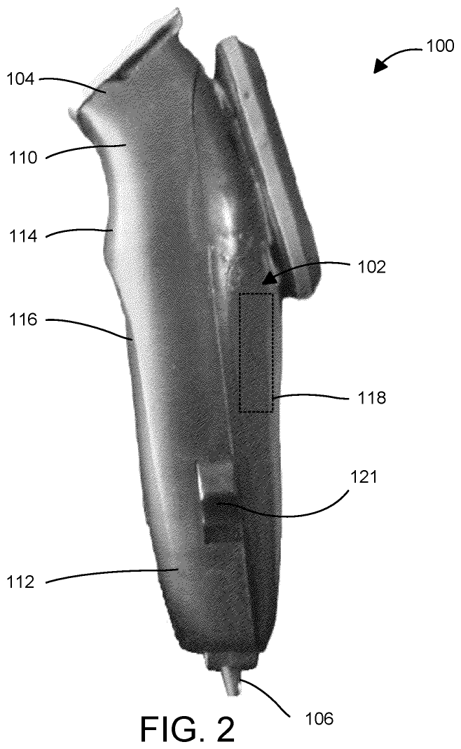

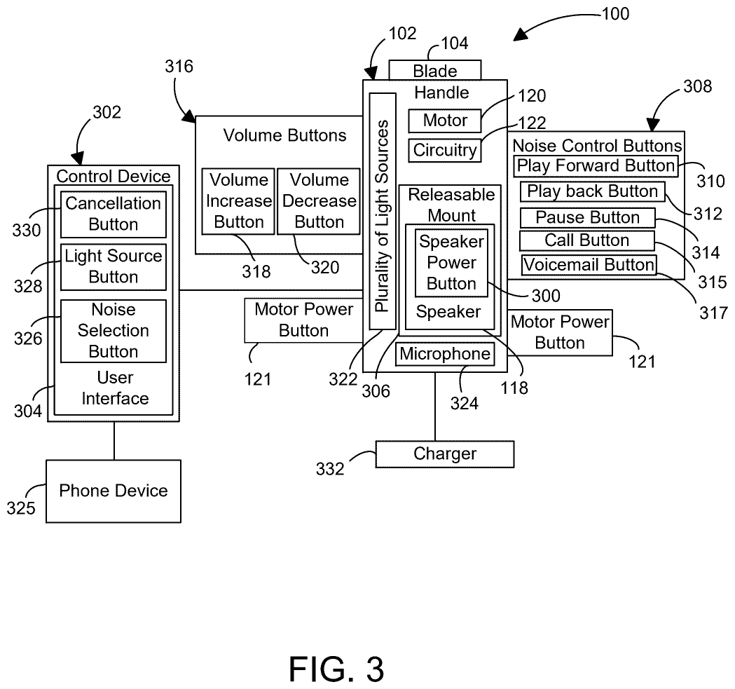

FIGS. 1-3 depict various embodiments of a clipper assembly 100 (e.g., barbering clipper, hair clippers, buzz cutter, trimmer, etc.). FIG. 1 shows a top view of the clipper assembly 100, FIG. 2 shows a side view of the clipper assembly 100, and FIG. 3 shows a block diagram of the clipper assembly 100, according to various embodiments. The clipper assembly 100 is configured to cut hair of a patient. The patient may have a sensitivity to a first noise emitted from the clipper assembly 100. In some embodiments, the patient has a noise sensitivity condition such as autism spectrum disorder or sensory processing disorder. The clipper assembly 100 can also be used with, by, for, etc. individuals without such disorders.

The clipper assembly 100 includes a handle 102 (e.g., grip, holder, hand hold, etc.), a blade 104 (e.g., cutting edge, razor, etc.), and a wire 106 (e.g., power cord, charging cord, wired connection, etc.). The handle 102 is to be gripped by a barber (e.g., user, hairdresser, etc.) and includes a first end 110 (e.g., primary base, first side, etc.) and a second end 112 (e.g., secondary side, second base, etc.). The handle 102 is oblong and includes a first curve 114 (e.g., arc, bend, curvature, etc.) connecting the first end 110 to a second curve 116 (e.g., arc, bend, curvature, etc.), and the second curve 116 connecting the first curve 114 to the second end 112. This shape helps aid the barber in gripping the handle 102. The wire 106 connects the clipper assembly 100 to a power source. The blade 104 is coupled to the second end 112 and oscillates under power from the motor 120 to cut the hair of the patient. In other embodiments, the handle 102 includes more or less than two curves. In other embodiments the handle 102 can include more or less than two ends (e.g., the handle 102 is spherically shaped with no distinct ends, etc.) or is a different shape (e.g., circular, rectangular, etc.). In other embodiments, the clipper assembly is wireless (e.g., wireless, etc.), and the wire 106 is omitted. The power source instead is a battery that is coupled to the clipper assembly 100 or disposed within the clipper assembly 100, and the clipper assembly 100 is rechargeable.

Disposed within the handle 102 between the first end 110 and the second end 112 are a speaker 118 (e.g., noise emitting device, loudspeaker, amplifier, etc.), a motor 120 (e.g., mechanism, etc.), and circuitry 122 (e.g., electrical system, circuit board, etc.) The motor 120 is operable to actuate the blade 104. The circuitry 122 is configured to control the motor 120 and the speaker 118 based on a signal (e.g., wireless signal) from a control device 302. The speaker 118 is configured to emit a noise (e.g., music, white noise, a telephone call, ring tone, etc.). In other embodiments, the speaker 118 may be coupled to an outside of the handle 102. In other embodiments, the speaker 118 may be located on the first end 110 or the second end 112. In other embodiments, the motor 120 or the circuitry 122 may be coupled to the outside of the handle 102. In other embodiments, the circuitry 122 is configured to control only the motor 120.

A releasable mount 306 is coupled to the handle 102 and the speaker 118 (e.g., MEMS speaker, subwoofer, electrodynamic speaker, etc.) is removably fixed to the handle by coupling the speaker 118 to the releasable mount 306. The speaker 118 is electrically coupled to the circuitry 122. In some embodiments, the speaker 118 can be removed from the releasable mount 306 and plugged into a power source or be wirelessly charged. In other embodiments, the releasable mount 306 is omitted and the speaker 118 is removably fixed (e.g., removable without tools or with a simple tool, without wiring changes, without destroying the product, etc.) to the handle 102. In some embodiments, the speaker 118 is permanently fixed (e.g., cannot be removed without destroying the product, cannot be accessed with simple tools, etc.) inside the handle 102 and includes a speaker power button 300 (e.g., switch, flip, knob, etc.). The speaker power button 300 can be accessed from an outside of the clipper assembly 100 to turn the speaker 118 on or off. In some embodiments the speaker 118 can be remotely charged through an external device or pad or charged through the circuitry 122. In some embodiments the speaker 118 is remotely connected to the control device 302. In some embodiments, the speaker 118 is removably or permanently fixed to or within the control device 302. In other embodiments the connection of the speaker 118 to the circuitry 122 is omitted. In other embodiments, the handle 102 includes a port enabling access to the speaker 118 so the speaker 118 can be plugged into a power source and charged. In other embodiments, the speaker 118 is charged by the same port or wire 106 as the clipper assembly 100. In other embodiments the speaker power button 300 on the handle is omitted. Instead, the speaker 118 is turned on through a user interface 304 of the control device 302.

The handle 102 also includes noise control buttons 308 (e.g., media control knobs, etc.). The noise control buttons 308 include a play forward button 310 (e.g., forward button, forward knob, forward switch, etc.), a play back button 312 (e.g., back button, backward knob, backward switch, etc.), a pause button 314 (e.g., status button, play button, etc.), a call button 315 (e.g., answer button, end button, etc.), and a voicemail button 317 (e.g., forward call button, etc.) contiguous with the handle 102. Responsive to a user interaction with the play forward button 310 (e.g., response to a press of the play forward button 310), the circuitry 122 is configured to skip the noise emitted by the speaker 118. Responsive to a user interaction with the play back button 312, the circuitry 122 is configured to replay the noise emitted by the speaker 118. Responsive to a user interaction with the pause button 314, the circuitry 122 is configured to pause the noise emitted by the speaker 118. Responsive to a user interaction with the call button 315, the circuitry 122 is configured to accept an incoming call or end a current call (e.g., the control device 302 is configured to connect or disconnect to a phone device 325, etc.). When the incoming call is accepted, the speaker 118 is configured to emit a second noise (e.g., the voice of the caller, etc.). In some embodiments, the speaker 118 emits the second noise in addition to the noise (e.g., the speaker 118 emits both a white noise to dampen the sound of the motor 120 and the voice of the caller, etc.). In some embodiments, the speaker 118 emits the second noise instead of the noise (e.g., the music is paused and the speaker 118 emits the voice of the caller, etc.). Responsive to a user interaction with the voicemail button 317, the circuitry 122 is configured to forward an incoming call to voicemail (e.g., the control device 302 is configured to forward the call from the phone device 325 to voicemail, etc.). In some embodiments, the phone device 325 is a landline phone or device for connecting to a landline phone line (e.g., a base of a cordless landline phone, etc.). In some embodiments, the phone device 325 is a cell phone.

In other embodiments, the noise control buttons 308 are omitted. In other embodiments, only one or two of the noise control buttons 308 are coupled to the handle 102 (i.e., only the pause button 314 is coupled to the handle). In other embodiments any of the noise control buttons 308 are omitted from the handle 102 and are located on the control device 302. In other embodiments, the noise control buttons 308 are located on the handle 102 and the user interface 304 of the control device 302. In other embodiments the circuitry 122 is configured to fast-forward through a portion of the noise emitted by the speaker 118 responsive to user interaction with the play forward button 310. In some embodiments the circuitry 122 is configured to play the noise responsive to user interaction with the pause button 314. In some embodiments, the circuitry 122 is configured to rewind a portion of the noise emitted by the speaker 118 responsive to user interaction with the play back button 312. In other embodiments the circuitry 122 is configured to rewind to a previous noise that the speaker 118 played responsive to user interaction with the play back button 312.

The handle 102 includes a motor power button 121 (e.g., power switch, control knob, etc.). The circuitry 122 is configured to turn the motor 120 on or off responsive to a user interaction with the motor power button 121. In other embodiments the motor power button 121 is omitted from the handle 102 and the motor power button 121 is located on the control device 302. In other embodiments the motor power button 121 is a knob (e.g., slider, etc.) that can increase or decrease the power input to the motor 120 to achieve a desired motor 120 speed.

The handle 102 also includes volume buttons 316 (e.g., sound knobs, amplification switch, etc.) continuous with the handle 102. The volume buttons 316 include a volume increase button 318 contiguous with the handle 102 and a volume decrease button 320 contiguous with the handle 102. The circuitry 122 is configured to increase a volume of the noise emitted by the speaker 118 responsive to user interaction with the volume increase button 318. The circuitry 122 is configured to decrease the volume of the noise emitted by the speaker 118 responsive to user interaction with the volume decrease button 320. The circuitry 122 is configured to adjust a volume of noise emitted by the speaker 118 response to user interaction with the volume buttons 316. In other embodiments, the volume buttons 316 are omitted. In other embodiments, there is only one volume button 316 coupled to the handle 102. In other embodiments, the volume buttons 316 are a single scroll wheel that adjusts the volume of the noise up or down. In other embodiments one or more of the volume buttons 316 are located on the user interface 304 of the control device 302.

The clipper assembly 100 includes one or more light sources, shown as a plurality of light sources 322 (e.g., LEDs, light emitting devices, bulbs, etc.). The plurality of light sources 322 are imbedded in the handle 102. The circuitry 122 is configured to adjust light emitted from the plurality of light sources 322 based on the wireless signal from the control device 302. The plurality of light sources 322 can be programmed on the user interface 304 of the control device 302 to flash in a pattern, display specific colors, and display different intensities of light when the user interacts with a light source button 328. In some embodiments the plurality of light sources 322 is omitted. In other embodiments the plurality of light sources 322 are preset by a manufacturer to be one setting of color, flashing, and intensity. In other embodiments the plurality of light sources 322 do not flash. In other embodiments one or more of the programmable settings for the plurality of the light sources 322 are omitted (i.e., only the color and intensity can be programmed). For example, the plurality of light sources 322 flashing may be overwhelming for some patients with sensory processing disorders. Removing the option of allowing the plurality of light sources 322 to flash can remove a potential trigger for these patients.

In some embodiments, the clipper assembly 100 includes a microphone 324 (e.g., ribbon microphone, condenser microphone, dynamic microphones, omnidirectional microphones, etc.) coupled to the handle 102. In other embodiments, the microphone 324 is omitted from the handle 102 and is instead placed near a workstation where the haircut is occurring and/or may be included in the control device 302. The microphone 324 is configured to collect (e.g., measure) a first noise profile of the motor 120 and the blade 104. The microphone 324 can provide the first noise profile to the control device 302, for example via circuitry 122. The control device 302 is configured to (e.g., programmed to) analyze the first noise profile, for example by applying the first noise profile as an input to a machine-learnt model, rules-based logic, or other algorithm (e.g., using fast Fourier transforms, spectral analysis, or the like) and, based on such analysis, create a second noise profile determined based on the first noise profile. For example, the control device 302 may be configured to determine soundwave characteristics of the first noise profile create a second noise profile having substantially offset soundwaves for active noise cancellation and/or otherwise adapted to mask, dampen, suppress, blend with, etc. the first noise profile. The control device 302 can transmit the second noise profile to the circuitry 122.

Responsive to receiving the second noise profile from the control device 302, the circuitry 122 is configured to control the speaker 118 to emit the second noise profile to at least partially cancel the first noise profile via additive interactions between soundwaves of the first noise profile and soundwaves of the second noise profile. Sound detected by the microphone 324 can be used by the circuitry 122 to dynamically adjust the phase, amplitude, and/or frequency of the second noise profile in a feedback control process to drive down a net sound experienced at the microphone 324.

The microphone 324 is also configured to collect (e.g., measure) a third noise profile of a voice (e.g., of the barber or other individual providing the haircut, etc.). The microphone 324 can provide the third noise profile to the control device 302, for example via circuitry 122, and the control device 302 can transmit the third noise profile to the phone device 325. Responsive to the control device 302 receiving a fourth noise profile from the phone device 325, the circuitry 122 is configured to control the speaker 118 to emit a second noise (e.g., the voice of the caller, etc.). In some embodiments, the speaker 118 is configured to emit both the first noise profile and the second noise. For example, the speaker 118 is configured to emit a white noise to provide active noise cancellation to the motor 120 and the blade 104 and to emit the voice of the caller. In some embodiments, the speaker 118 is configured emit both the noise and the second noise (e.g., the speaker 118 emits music and the voice of the caller, etc.). In some embodiments, the speaker 118 is configured to emit the noise, the first noise profile, and the second noise (e.g., the music, the white noise, and the voice of the caller, etc.). In some embodiments, the control device 302 is configured to connect with the phone device 325 and the speaker 118 is configured to emit the second noise responsive to user interaction with the call button 315. In some embodiments, the speaker 118 is configured to cease emission of the second noise and the control device 302 is configured to disconnect with the phone device 325 responsive to user interaction with the call button 315. In some embodiments, the speaker 118 is configured to alter the noise responsive to user interaction with the call button 315 (e.g., cease emitting a ringtone, etc.).

The control device 302 is remotely connected to the clipper assembly 100 and includes the user interface 304 coupled to the control device 302. The control device 302 can be used to remotely change the settings on the clipper assembly 100, and can be a personal computing device (e.g., smartphone, tablet, laptop, desktop computer, augmented reality headset, etc.) in various embodiments. The user interface 304 can be provided as a touch screen that displays a graphical user interface that includes graphical elements (e.g., buttons, etc.) that the user can use to interact with the control device 302. The control device 302 runs an application (e.g., program, etc.) that enables a user to select the noise via the user interface 304. The user interface 304 includes a noise selection button 326 (e.g., as a graphical user interface feature, as a physical button) to choose the noise (e.g., a song, a story recording, etc.) to emit from the speaker 118. In some embodiments, the control device 302 includes one or more of physical buttons, knobs, keys, etc. The control device 302 includes the light source button 328 to choose color, flashing settings, and intensity of light for the plurality of light sources 322.

In some embodiments the user interface 304 includes the volume buttons 316 (including the volume increase button 318 and the volume decrease button 320), the noise control buttons 308 (including the play forward button 310, the play back button 312, the pause button 314, and the call button 315), and the motor power button 121. In some embodiments the control device 302 is omitted and the settings (e.g., volume, noise, flashing, etc.) are controlled through interacting with buttons on the handle 102. In some embodiments some of the buttons are omitted from the user interface 304 (e.g., only the volume buttons 316 are included on the user interface 304). In some embodiments, the touch screen is omitted from the user interface 304 and the user interface 304 uses physical buttons (e.g., knobs, etc.) to control each of the settings. In some embodiments the control device 302 is wired to the clipper assembly 100 instead of being remotely connected. In some embodiments the control device 302 is coupled to the handle 102 of the clipper assembly 100 or embedded in the handle 102 of the clipper assembly 100. In some embodiments the light source button 328, the volume buttons 316, the noise control buttons 308, the motor power button 121, and the noise selection button 326 can be programmed to save preferences for each patient.

The control device 302 is also shown as including a cancellation button 330 which is selectable to cause the control device 302 to execute a noise cancellation process. In some embodiments, the noise cancellation process includes collecting the first noise profile via the microphone 324, analyzing the first noise profile, generating the second noise profile to cancel the first noise profile, and emitting the second noise profile. The first noise profile is collected from the microphone 324 and transmitted to the control device 302. The second noise profile is configured to cancel at least a portion of the first noise profile. The speaker 118 emits the second noise profile based on a wireless signal to the circuitry 122 from the control device 302. The second noise profile can be saved for future usage (e.g., the barber starts and stops the motor multiple times during cutting hair, the barber switches between motor speeds during cutting hair, etc.). In some embodiments, the control device 302 automatically proceeds with the noise cancellation process when the motor 120 is actuated. In some embodiments the circuitry 122 automatically performs the noise cancellation process inside the speaker 118. In some embodiments the noise selection button 326 can be programmed to emit both the noise and the second noise profile. In some embodiments, the noise selection button 326 can be programmed to emit the noise, the second noise profile, and the second noise.

### III. Example Haircut Process

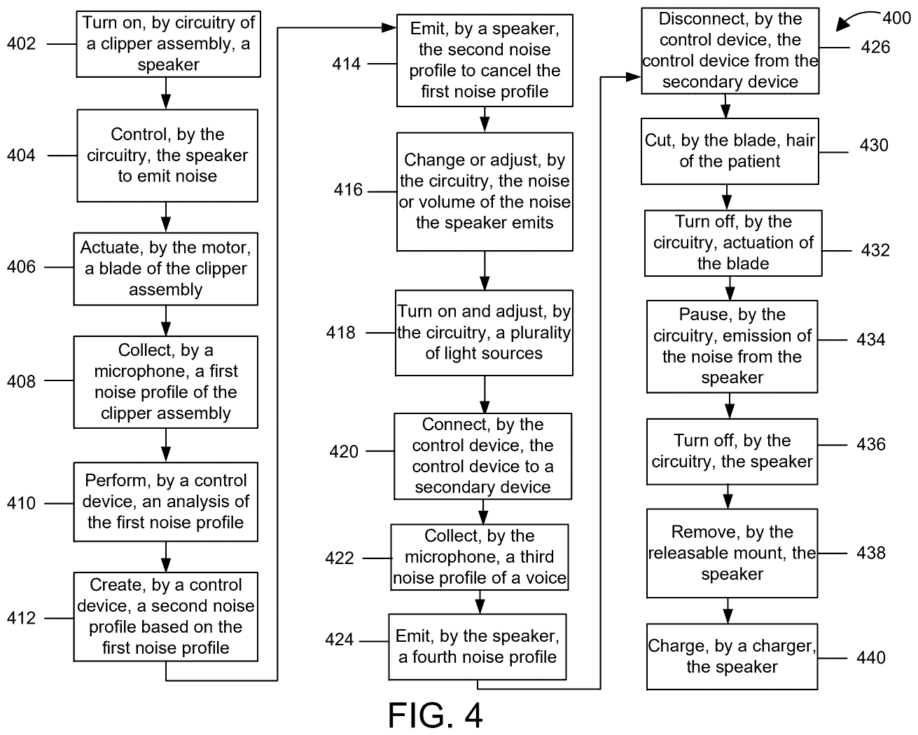

FIG. 4 illustrates a calming process 400 (e.g., method, etc.) for a patient with autism spectrum disorder (or other condition causing sensory sensitivity) receiving a haircut using the clipper assembly 100. The calming process 400 may be also performed for the benefit of a barber (e.g., hairdresser, stylist, beautician, coiffeur, etc.) or a non-professional home barber (e.g., parent, friend, neighbor, etc.) having a sensory sensitivity (e.g., caused by autism spectrum disorder or other condition).

The calming process 400 begins in block 402 with turning on, by the circuitry 122, the speaker 118. Block 402 can include interacting with the speaker power button 300 on the speaker 118. In other embodiments, block 402 includes interacting with the speaker power button 300 on the handle 102 of the clipper assembly 100. In some embodiments, block 402 includes turning the speaker 118 on through the user interface 304 on the control device 302.

The calming process 400 continues in block 404 with controlling, by the circuitry 122, the speaker 118 to emit a noise (e.g., a first noise, etc.). Block 404 can include interacting with the noise selection button 326 to choose the noise from the control device 302, transmit the first noise to the speaker 118, and play the noise on the speaker 118. In some embodiments, block 404 includes interacting with the pause button 314 to begin playing the first noise. In some embodiments, the noise is not chosen from the control device 302 and the user interacts with the pause button 314 to begin playing the noise that was paused or a preprogrammed noise.

The calming process 400 continues in block 406 with actuating, by the motor 120 of the clipper assembly 100, the blade 104 of the clipper assembly 100. Block 406 can include readying the position of the clipper assembly 100 so the blade 104 is positioned a distance from the barber, the patient, and any bystanders. Then, the motor 120 is turned on by the circuitry 122 when a user interacts with the motor power button 121. In some embodiments block 406 includes adjusting the speed of the motor 120 to the desired speed for the haircut.

The calming process 400 continues in block 408 with collecting, by the microphone 324, the first noise profile of the clipper assembly 100. When the user interacts with the cancellation button 330, the control device 302 begins to execute a noise cancellation process. The first noise profile is collected by the microphone 324, and includes noise produced by the motor 120 and a surrounding environment. The first noise profile is transmitted to the control device 302. In some embodiments, block 408 performed automatically by the circuitry 122 within the speaker 118 instead of the control device 302. In some embodiments the first noise profile is saved in the control device 302 or a cloud server for later usage. In some embodiments block 408 is carried out automatically in the control device 302 without interacting with the cancellation button 330.

The calming process 400 continues in block 410 with performing an analysis, by the control device 302, of the first noise profile of the motor 120 and the blade 104 of the clipper assembly 100. Block 410 will automatically occur after block 408. In some embodiments the circuitry 122 within the speaker 118 performs the analysis of the first noise profile. In some embodiments an analysis is saved on the control device 302 or a cloud server for later usage.

The calming process 400 continuous in block 412 with creating, by the control device 302, the second noise profile based on analysis of the first noise profile. The control device 302 creates a second noise profile that is approximately equal and opposite the first noise profile to cancel out at least a portion of the first noise profile. Block 412 occurs automatically after block 410. In some embodiments, block 412 is performed by the circuitry 122 within the speaker 118. In some embodiments the second noise profile is saved in the control device 302 or a cloud server for later usage.

The calming process 400 continues in block 414 with emitting, by the speaker 118, the second noise profile to cancel the first noise profile at least partially. The speaker 118 emits the second noise profile based on a wireless signal to the circuitry 122 from the control device 302. Block 414 occurs automatically after block 412. In some embodiments, block 414 is performed by the circuitry 122 within the speaker 118.

The calming process 400 continues in block 416 with changing or adjusting, by the circuitry 122 of the clipper assembly 100, the noise or volume the speaker 118 emits to a comforting level for the patient. The control device 302 transmits the wireless signal to the circuitry 122. In some embodiments, block 416 includes the circuitry 122 adjusting a volume of the speaker 118 when a user interacts with the volume buttons 316. Block 416 can include the circuitry 122 increasing the volume of the noise when a user interacts with the volume increase button 318 and decreasing the volume of the noise when a user interacts with the volume decrease button 320. In some embodiments block 416 includes the circuitry 122 changing the noise the speaker 118 emits to a second noise (e.g., a song, an audiobook, etc.) when a user interacts with the noise selection button 326. In some embodiments block 416 includes the speaker 118 emitting both the noise from block 404 and the second noise profile responsive to a user interacting with the noise selection button 326. In some embodiments block 416 includes the speaker 118 emitting only the noise from block 404 or the second noise profile responsive to user interaction with the noise selection button 326. In some embodiments, the increasing and decreasing the volume is completed by the circuitry 122 when the user interacts with a single adjustable knob or scroll wheel instead of two different buttons. In some embodiments the volume adjustment is completed by the control device 302 in response to user interaction with the user interface 304. In some embodiments the volume or the noise preference is saved on the control device 302 or a cloud server as a preference setting for the patient. In some embodiments changing the noise includes the circuitry 122 fast forwarding through or skipping emission of the noise from the speaker 118 in response to user interaction with the play forward button 310. In some embodiments changing the noise includes the circuitry 122 repeating or rewinding emission of the noise from the speaker 118 in response to user interaction with the play back button 312. In some embodiments changing the noise includes the circuitry 122 pausing or playing the emission of the noise from the speaker 118 in response to user interaction with the pause button 314.

The calming process 400 continues in block 418 with turning on and adjusting, by the circuitry 122 of the clipper assembly 100, light emitted from the plurality of light sources 322 based on a wireless signal to the circuitry 122 from the control device 302. The wireless signal from the control device 302 is in response to user interaction with the control device 302. Block 418 can include the circuitry 122 adjusting the color, flashing, and intensity of the plurality of light sources 322 and turning any number of the plurality of light sources 322 on or off. In some embodiments the plurality of light sources 322 are emitted and calming process 400 abstains from performing block 418. In some embodiments block 418 abstains from controlling one or more of the color, flashing, and intensity of the plurality of light sources 322. In some embodiments the circuitry 122 turns on the plurality of light sources 322 when the motor 120 is actuated as in block 406.

The calming process 400 continues in block 420 with connecting, by the control device 302, the control device 302 to the phone device 325. The control device 302 detects an incoming signal (e.g., call, etc.) from the phone device 325 and alerts a user by altering the noise. Block 420 can include changing the noise to a ring tone. Block 420 can include a ring tone being emitted in addition to the noise (e.g., the ring tone is emitted over the music, etc.). Block 420 can include a user interacting with the call button 315 to receive the call, connect the control device 302 to the phone device 325, and cease emitting the ringtone or the user interacting with the voicemail button 317 to forward the call to voicemail and cease emitting the ringtone.

The calming process 400 continues in block 422 with collecting, by the microphone 324, a third noise profile of a voice. When the user interacts with the call button 315 to receive the call in block 420, the microphone 324 begins collecting (e.g., monitoring for, etc.) the third noise profile of one or more user's voices. The third noise profile is transmitted, by the control device 302, to the phone device 325.

The calming process 400 continues in block 424, with emitting, by the speaker 118, a fourth noise profile (e.g., a caller's voice, etc.). The fourth noise profile is transmitted from the phone device 325 to the control device 302, and from the control device to the speaker 118. In some embodiments, the fourth noise profile is emitted at the same time as the noise (e.g., the voice of the caller is emitted at the same time as the music, etc.). In some embodiments, only the fourth noise profile is emitted, and the noise and the second noise profile cease being emitted (e.g., only the voice of the caller is emitted during the call, etc.). In some embodiments, the fourth noise profile and the second noise profile are emitted (e.g., both the voice of the caller and the white noise to cancel the noise of the motor 120 and the blade 104 are emitted, etc.). In some embodiments, the noise, the second noise profile, and the fourth noise profile are emitted (e.g., the white noise to cancel the noise of the motor 120 and the blade 104, the voice of the caller, and the music are emitted, etc.).

The calming process 400 continues in block 426, with disconnecting, by the control device 302, the control device 302 from the phone device 325. Block 426 can include the user interacting with the call button 315 to disconnect the control device 302 from the phone device 325 to end the call. In some embodiments, the control device 302 disconnects from the phone device 325 responsive to the phone device 325 disconnecting the call (e.g., the caller hangs up the call, etc.).

The calming process 400 continues in block 430 with cutting, by the blade 104, the hair of the patient with the blade 104 while emitting, by the speaker 118, the noise and/or the second noise. In some embodiments, any of blocks 408-426 can be repeated during block 430 in accordance with the needs of the patient. For example, the circuitry 122 may increase the speed of the motor 120 and the circuitry 122 may generate another second noise profile to cancel the first noise profile emitted from the motor 120 and blade 104 in response to user interaction with the cancellation button 330.

The calming process 400 continues in block 432 with turning off, by the circuitry 122, actuation of the blade 104 of the clipper assembly 100 when the hair cut is complete. The circuitry 122 turns of the motor 120 and therefore the blade 104 in response to user interaction with the motor power button 121. In other embodiments, block 432 occurs anytime during the hair of the patient being cut. In other embodiments block 432 occurs between or during any of blocks 408-430. For example, the patient wants to take a break while the hair is being cut. In other embodiments the motor 120 and blade 104 are turned off through a wireless signal received by the circuitry 122 from a user interaction with the user interface 304 of the control device 302.

The calming process 400 continue in block 434 with pausing, by the circuitry 122 of the clipper assembly 100, emission of the noise from the speaker 118. Block 434 includes the circuitry 122 pausing emission of the noise from the speaker 118 in response to user interaction with the noise selection button 326 on the user interface 304 of the control device 302. In other embodiments the noise is paused by the circuitry 122 in response to user interaction with the pause button 314. In other embodiments, the noise is paused by the circuitry 122 when the motor 120 is turned off in block 432.

The calming process 400 continues in block 436 with turning off, by the circuitry 122, the speaker 118. Block 436 can include the circuitry 122 turning off the speaker 118 responsive to user interaction with the speaker power button 300 on the speaker 118. In other embodiments, block 436 includes the circuitry 122 turning off the speaker 118 responsive to user interaction with the speaker power button 300 on the handle 102 of the clipper assembly. In other embodiments, block 436 includes the circuitry 122 receiving a wireless signal responsive to user interaction with the user interface 304 on the control device 302.

The calming process 400 continues in block 438 with removing, by the releasable mount 306, the speaker 118. In other embodiments the calming process 400 abstains from performing block 438, and the speaker 118 is permanently fixed to or inside the handle 102. In other embodiments, the speaker 118 is removably fixed to or within the handle 102 by an alternative method than the releasable mount 306, and is removed in an alternate manner (e.g., using simple tools, etc.).

The calming process 400 continues in block 440 with charging, by a charger 332, the speaker 118. In other embodiments the speaker 118 and the motor 120 are both charged through the same port. In some embodiments the charger 332 is a wireless charger. In some embodiments the speaker 118 and the motor 120 are both charged by a wireless charger.

### IV. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable, or releasable). Such joining may be achieved with the two components, or the two components and any additional intermediate components being integrally formed as a single monolithically body with one another, with the two components, or with the two components and any additional intermediate components being attached to one another. It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A clipper assembly comprising:
a handle comprising a first end and a second end;
a speaker positioned between the first end and the second end;
a blade coupled to the second end;
a motor positioned in the handle and operable to actuate the blade; and
circuitry configured to control the speaker and the motor.

2. The clipper assembly of claim 1, further comprising:
a volume button contiguous with the handle, wherein the circuitry is configured to adjust a volume of noise emitted by the speaker responsive to user interaction with the volume button.

3. The clipper assembly of claim 1, wherein the speaker is remotely connected to a control device, wherein the circuitry is configured to control the motor and the speaker based on a wireless signal from the control device.

4. The clipper assembly of claim 1, wherein the speaker is remotely connected to a control device, the clipper assembly further comprising:
a microphone positioned between the first end and the second end of the handle, the microphone configured to collect a first noise, the microphone remotely connected to the control device; and
a call button contiguous with the handle, wherein the control device is configured to remotely connect to a phone device and transmit the first noise to the phone device responsive to a user interaction with the call button;
wherein the speaker is configured to emit a second noise transmitted from the phone device to the control device responsive to user interaction with the call button.

5. The clipper assembly of claim 1, further comprising:
a plurality of light sources imbedded in the handle, wherein the circuitry is configured to adjust light emitted from the plurality of light sources based on a wireless signal from a control device.

6. The clipper assembly of claim 1, comprising a releasable mount, wherein the speaker is removably coupled to the handle via the releasable mount.

7. The clipper assembly of claim 1, further comprising:
a play forward button contiguous with the handle, wherein the circuitry is configured to skip a noise emitted by the speaker responsive to user interaction with the play forward button;
a pause button contiguous with the handle, wherein the circuitry is configured to pause the noise emitted by the speaker responsive to user interaction with the pause button; and
a play back button contiguous with the handle, wherein the circuitry is configured to replay the noise emitted by the speaker responsive to user interaction with the play back button.

8. The clipper assembly of claim 1, further comprising:
a microphone configured to collect a first noise profile of the motor and the blade;
wherein the circuitry is configured to control the speaker to emit a second noise profile determined based on the first noise profile, wherein the second noise profile is configured to cancel the first noise profile at least partially.

9. A method of calming a patient with autism spectrum disorder receiving a haircut, comprising:
turning on a speaker located inside a clipper assembly;
controlling the speaker to emit a noise;
actuating, by a motor of the clipper assembly, a blade of the clipper assembly; and
cutting, by the blade, hair of the patient while emitting, by the speaker, the noise.

10. The method of claim 9, further comprising:
performing an analysis of a first noise profile of the motor and the blade of the clipper assembly;
creating a second noise profile based on the analysis of the first noise profile; and
emitting the second noise profile from the speaker to cancel the first noise profile.

11. The method of claim 9, further comprising:
adjusting, by circuitry of the clipper assembly, a volume of the speaker to a comforting level for the patient based on a wireless signal to the circuitry from a control device.

12. The method of claim 9 further comprising:
connecting a control device to a phone device responsive to a user input to a call button of the clipper assembly;
receiving, by the control device, a second noise from the phone device;
emitting, by the speaker, the second noise;
collecting, by a microphone located inside the clipper assembly, a third noise; and
transmitting, by the control device, the third noise from the control device to the phone device.

13. The method of claim 9, further comprising:
turning off, by controlling the motor, actuation of the blade;
pausing, by circuitry of the clipper assembly, emission of the noise from the speaker;
turning off the speaker; and
charging, by a charger, the speaker.

14. The method of claim 9, wherein the noise is a first noise, further comprising:
changing, by a circuitry of the clipper assembly, the first noise the speaker emits to a second noise based on a wireless signal to the circuitry from a control device.

15. The method of claim 9, further comprising:
skipping, by circuitry of the clipper assembly, emission of the noise from the speaker in response to a user input to a play forward button of the clipper assembly.

16. The method of claim 9 further comprising:
pausing, by circuitry of the clipper assembly, emission of the noise from the speaker in response to a user input to a pause button of the clipper assembly.

17. The method of claim 9 further comprising:
repeating, by circuitry of the clipper assembly, emission of the noise from the speaker in response to a user input to a play back button of the clipper assembly.

18. The method of claim 9 further comprising:
adjusting, by circuitry of the clipper assembly, a volume of the speaker in response to a user input to a volume button of the clipper assembly.

19. The method of claim 9 further comprising:
adjusting, by circuitry of the clipper assembly, light emitted from a plurality of light sources imbedded in the clipper assembly based on a wireless signal to the circuitry from a control device.

20. A method of calming a patient with a sensory processing disorder receiving a haircut comprising:
turning on a speaker located inside a clipper assembly;
controlling the speaker to emit a noise;
actuating, by a motor of the clipper assembly, a blade of the clipper assembly; and
cutting, by the blade, hair of the patient while emitting, by the speaker, the noise.
